(19) United States
(12) Patent Application Publication
(10) Pub. No.: US 2006/0034029 A1
(43) Pub. Date: Feb. 16, 2006

(54) Current detector with improved resistance adjustable range and heat dissipation

(75) Inventor: Chung Hsiung Wang, Hsin Chu (TW)

Correspondence Address: Bo-In Lin, 13445 Mandoli Drive, Los Altos Hills, CA, 94022, US

(73) Assignee: CYNTEC COMPANY

(21) Appl. No.: 11/204,566

(22) Filed: Aug. 15, 2005

Related U.S. Application Data
(60) Provisional application No. 60/601,673, filed on Aug. 13, 2004.

(51) Int. Cl. H02H 5/04

(52) U.S. Cl. 361/103

(57) ABSTRACT

This invention discloses a current detector formed on a multiple-layered structure with a resistor supported thereon. The multiple-layered structure further includes a heat dissipation layer for dissipating heat generated from the resistor. In a preferred embodiment, the current detector further includes conductive blocks formed by a microelectronic casting process for functioning as part of electrodes for the current detector. In another preferred embodiment, the current detector further includes wrapping around electrodes each with a side conductive surface wrapping around a side surface of the multiple-layered structure.

This Formal Application claims a Priority Date of Aug. 13, 2003 benefit from a Provisional Patent Applications 60/601,673 filed by the same Applicant of this Application respectively. The Provisional Application 60/601,673 is hereby incorporated by reference.

### BACKGROUND OF THE INVENTION

1. Field of the Invention

This invention relates generally to the device configuration and processes for manufacturing a current detector. More particularly, this invention relates to an improved configuration and process for manufacturing a micro low voltage and low resistance current detector.

2. Description of the Prior Art

For those of ordinary skill in the art, the configurations and the process of manufacturing a high current inductor coil are still faced with technical challenges that inductor coils manufactured with current technology still does not provide sufficient compact form factor often required by application in modern electronic devices. Furthermore, conventional inductor coils are is still manufactured with complicate manufacturing processes that involve multiple steps of epoxy bonding and wire welding processes.

A current detector is commonly implemented in the protection circuit of a power supply of a server or a desktop computer. A current detector is also implemented in the control circuit of a charger. The current detectors, which are implemented in the protection circuit of a power supply and in the motor control circuit, are employed to control the current to achieve the purpose of circuit protection. For example, the current detector in a power supply is to control the amount of discharging or charging current and to stabilize the load. A current detector in a motor is to control the motor speed. Referring to FIG. 1 for a typical protection circuit. Under the circumstance when the load is low, a current is conducting along a direction as indicated by the symbol 1. On the other hand, when the load is increased to a certain value such that the transistor Tr2 becomes conductive, the current then conducts along a direction as marked by a symbol 2 thus activating transistor Tr1, and therefore, the load is protected form a current overflow. In order to increase the amount of current in the circuit, the resistor is Re is implemented with a very low resistance to reduce the amount of heat generated since the heat is generated according to P=I²R, where P is the amount of heat, I is the current and R is the resistance. Furthermore, resistors of very low resistance are also implemented in the central processing unit (CPU) of a computer to achieve the purpose of power savings and reduced heat generation, particularly, in the MOS transistors when the current is applied to control the operation of the transistors. For these reasons, a current detector operated at a low voltage with very low resistance is required for many applications in modem electronic devices.

There are several kinds of current detectors currently available. A metal current detector is shown in FIG. 2A that includes two metal terminals 201 and 202 interconnected with an alloy plate 203 covered by a protective resin layer 204. The alloy plate 203 is a thick layer. According to the formula for computing resistance, i.e., R=Rs(L/W), where Rs is a the resistance of a unit volume of the alloy plate 203, L is the length of the plate and W is the thickness, a thickness alloy plate 203 reduces the resistance of the current detector. This type of current detector has several limitations. A first limitation is its difficulty of manufacture especially when the metallic foil has to become thinner to obtain a higher value of resistance. The range of resistance of this type of current detector is therefore limited in a range between one to ten milliohms. Another limitation is the requirement of employing a resin protection layer as a support, particularly when the foil is very thin. The resin has poor heat dissipation rate. Additionally, the resistance of the metallic foil current detector is adjusted and controlled by mechanical trimming techniques. The mechanical trimming techniques are difficulty to control and thus can produce current detector with resistors of limited accuracy.

FIG. 2B is a perspective view of another current detector supported on a substrate 212 where metal traces 212 are formed to connect with terminal leads 214 and 214 to connect with external circuits. The conductive traces are formed by spinning spreading the resin onto the substrate as an insulation layer then a metallic foil is formed on top of the resin layer. A photolithographic method is applied to control the etch of the metallic foil thus forming the conductive trace 212 with more accurately controllable resistance. Due to the requirement that extra manufacturing steps must be carried out to connect the terminal leads 213 and 214 for the current detector as shown in FIG. 2B, the production cost is higher. The manufacturing processes are more time consuming. Also, the terminal leads 213 and 214 add resistance to the circuit, such current detector is therefore limited in its value of resistance and is not able for implementation in application that requires lower resistance. Since the configuration of the current detector is not suitable for surface mount (SMD) application, an extra processing step is required to connect the terminal leads 213 and 214 to external circuits thus increasing the cost or implementation.

FIG. 2C shows a thin film current detector provided with a thin film metallic resistor layer 222 sputtering on and supported on a aluminum oxide substrate 221. The thin film layer is then trimmed to obtain a targeted value of resistance followed by forming the surface-mounting terminals 223on either ends of the substrate and covering the resistor with a passivation layer 224. By applying a laser trimming process, the value of the resistance can be more accurately controlled. However, the thin film process in forming the resistive layer 222 is carried out in the vacuum, and the film formation process is slow and the resistance rang is usually above 10 milliohms. Due to the slow process in forming the resistive layer, it has a higher production cost. The detector further has poor heat dissipation.

FIG. 2D shows a thick film current detector having substantially a same structural configuration as that of FIG. 2C where the resistive layer 232 is formed by applying a printing or a high temperature process. The production cost is lower than the thin film detector. The thin film resistive layer is bonding to the substrate and therefore cannot provide a resistance lower than 10 milliohms. Due to the bonding between the resistive film and the substrate, micro-cracks often occur when a laser trimming process is applied. For this reason, the detector is therefore only applicable as detector in a low voltage circuit. Furthermore, due to the poor heat dissipation, the detector can only be employed in circuits with a low rate of heat generation.

FIG. 2E shows a current detector formed by a high temperature MLCC process on a ceramic substrate. The process is similar to that of a thick film process with the only difference that it applies a high temperature above 850 degrees Celsius. The resistance layer 241 and ceramic layer 242 are bonded under high temperature process. The electrodes 243 and 244 are then formed. Due to the bonding of the resistor and the ceramic layer, the accuracy of resistance cannot be conveniently controlled and adjusted. The accuracy of the current detector is therefore degraded. This detector has the same problem that the current detect is not provided with an effective heat dissipation.

Therefore, a need still exists in the art of design and manufacture of current detector to provide a novel and improved device configuration and manufacture processes to resolve the difficulties.

### SUMMARY OF THE PRESENT INVENTION

It is therefore an object of the present invention to provide a new structural configuration and manufacture method for manufacturing a current detector that includes a heat dissipation layer and terminals formed with casting process with increased thickness and reduced resistance such that the above discussed problems and limitations are resolved.

Specifically, this invention discloses a method for manufacturing a current detector with a low resistance by applying an electric casting technique to increase the thickness of the electrode. With thicker electrode layer, the resistance of the current detector is reduced.

It is another object of the present invention to improve the heat dissipation of the current detector by attaching a heat conductive layer at the bottom of the supporting substrate. The heat dissipating layer is further in physical contact with a bottom electrode with increased thickness to effectively dissipating the heat generated by the current detector.

It is another object of this invention to provide flexibilities for manufacturing a current detector to operate for different applications. Each of the key steps of the manufacturing processes is flexibly adjustable to provide a current detector suitable for application for different power and current levels with different heat dissipation and resistance requirements.

It is another object of the invention to provide a current detector with a surface mount configuration and is further provided with side contact surfaces for conveniently mounting and connecting to different circuits.

Briefly, in a preferred embodiment, the present invention includes a current detector formed on a multiple-layered structure with a resistor supported thereon. The multiple-layered structure further includes a heat dissipation layer for dissipating heat generated from the resistor. In a preferred embodiment, the current detector further includes conductive blocks formed by a microelectronic casting process for functioning as part of electrodes for the current detector. In another preferred embodiment, the current detector further includes wrapping around electrodes each with a side conductive surface wrapping around a side surface of the multiple-layered structure.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

Fig. is a circuit diagram of protective circuit implementing a current detector.

FIGS. 2A to 2E are perspective views for showing conventional current detectors manufactured by different processes.

FIG. 3 is a perspective view of a current detector of this invention.

FIGS. 4A to 4E are a series of perspective views for showing the manufacturing processes to form the current detector of this invention.

FIGS. 5A to 51 are a series of side cross sectional views for showing the manufacturing processes to form the current detector of this invention.

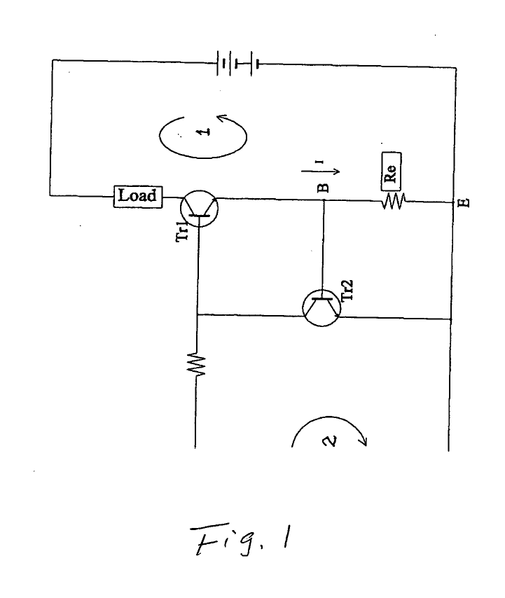

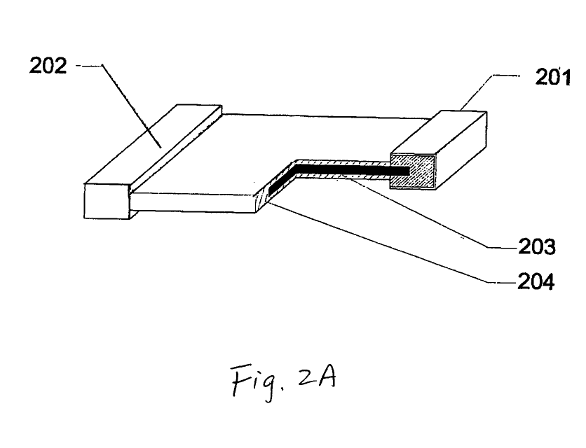

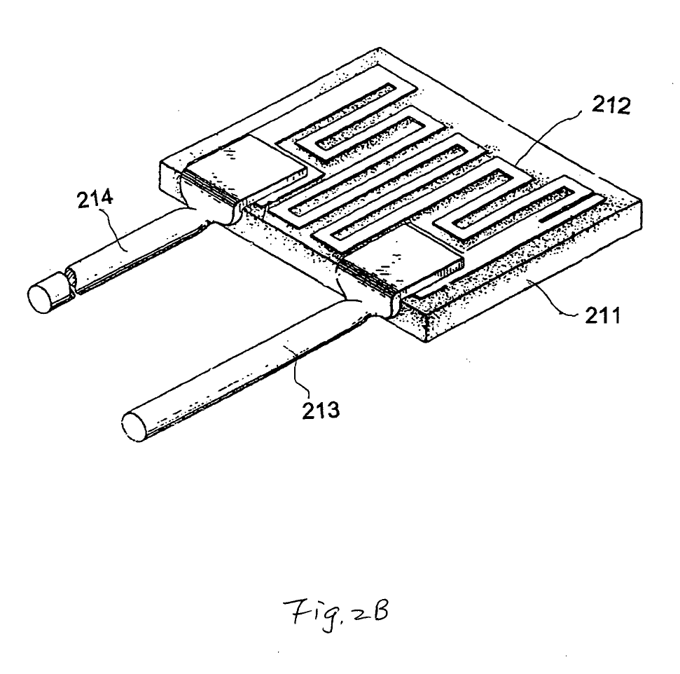

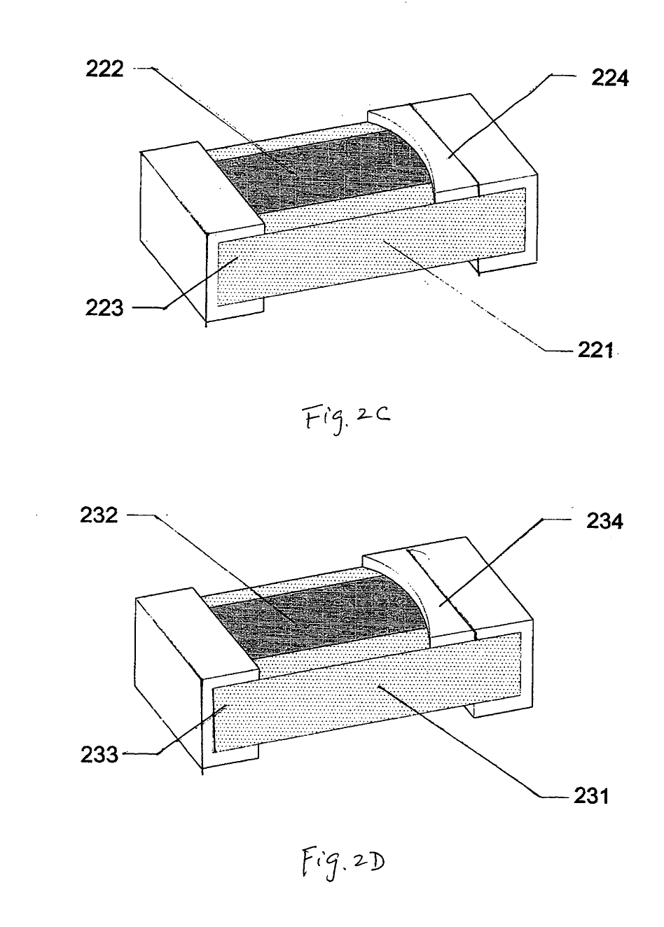

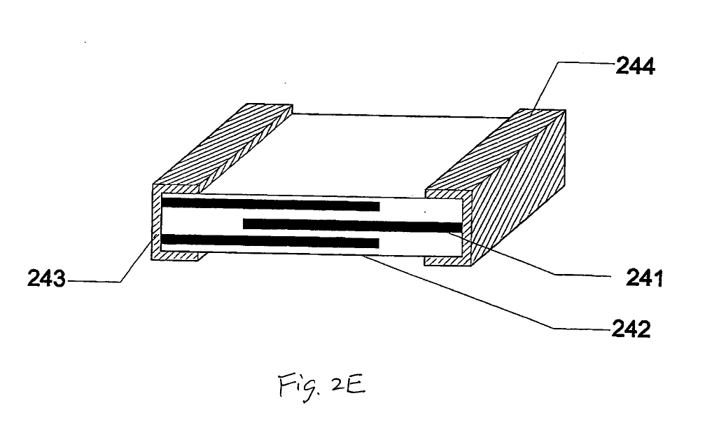

### DETAILED DESCRIPTION OF THE PREFERRED EMBODIMENT

Referring to FIG. 3 for a current detector of this invention. The current detector includes a detector body 1 and terminals 2 disposed on either sides of the body 1. The detector body is formed as a multiple-layer structure includes a middle substrate layer 10. In a preferred embodiment, the substrate layer 10 is formed as an aluminum oxide layer or a metal layer 10. A bottom heat dissipation layer 11 is attached on the bottom surface of the substrate 10 and a top heat dissipation layer 12 is attached on the top surface of the substrate 10. These heat dissipation layers 11 and 12 composed of FRP epoxy or other attachment agents with high heat conductivity. A resistive layer 13 is formed on top of the top heat dissipation layer 12 and the resistive layer 13 is covered with a protective layer 15. A heat dissipation layer 14, which preferable is a cooper layer is formed below the bottom heat dissipation layer 11 and the heat dissipation layer 14 is covered and protected by a bottom protective layer 16. The protective layers 15 and 16 are preferably resin layers.

Two casting cooper blocks 17 and 18 are formed on top of the terminals 2 on either side of the detector body 1. A sputtering process is applied to form an electric terminal 20 wrapping around the top, bottom and the side surfaces of the detector body 1.The terminals 19 and 20 are then covered with a cooper, nickel, tin or lead layer.

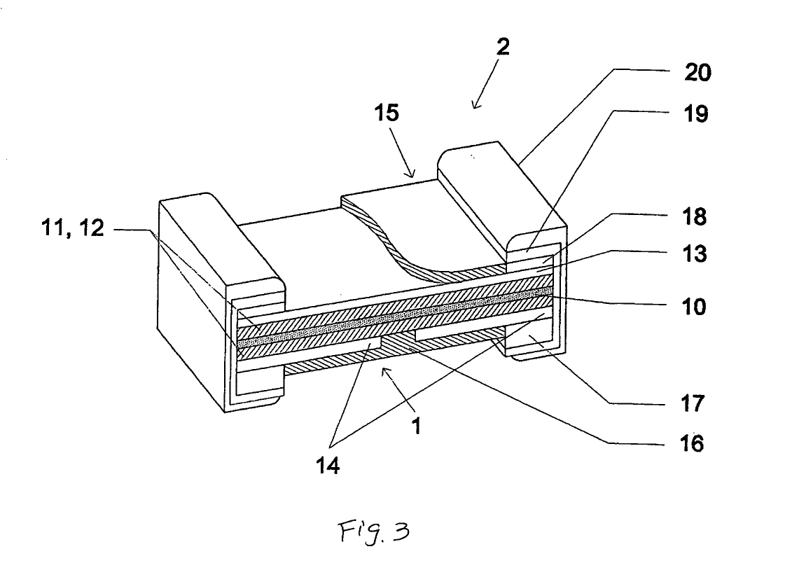

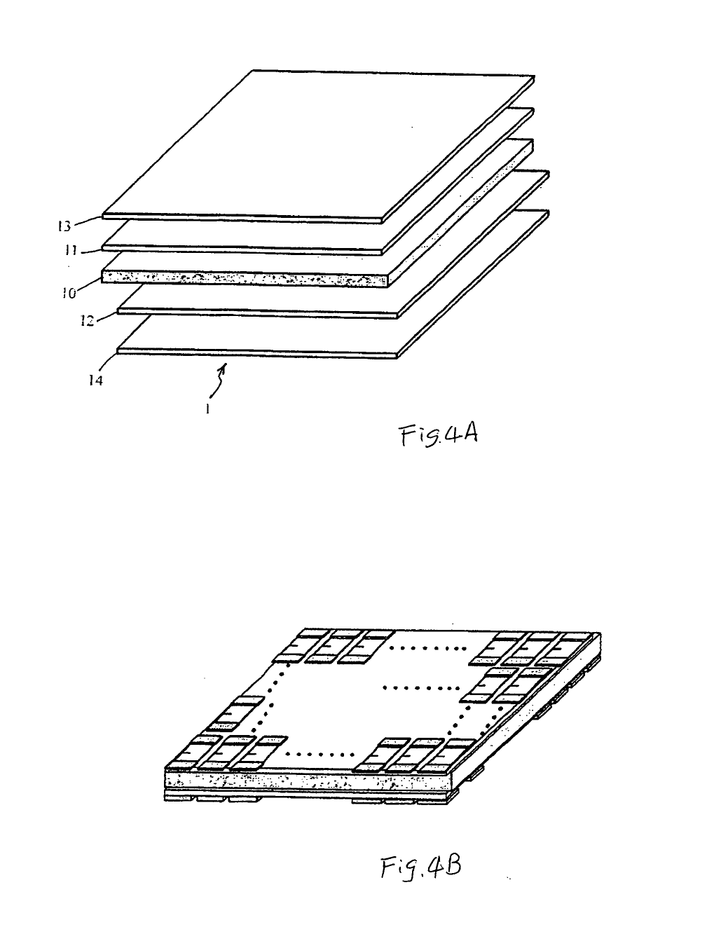

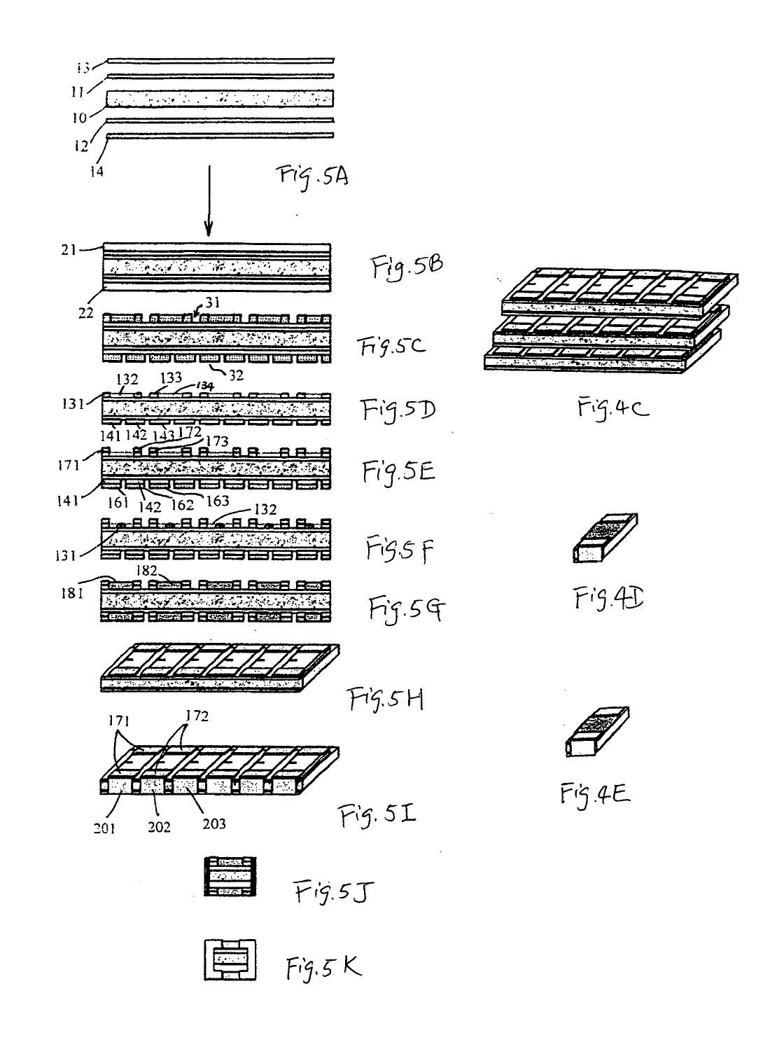

Referring to FIGS. 4A to 4E and FIGS. 5A to 5K for a series of processing steps to form the detector as disclosed in FIG. 3. In FIG. 4A, a multiple-layer structure is formed with a middle substrate layer 10, top and bottom heat conducting attaching layers 11 and 12 respectively and a resistive layer 13 on the top and a heat dissipation layer 14. After pressing and forming the multiple-layered structure, a mask layer 21 and 22 are place on top and bottom of the multiple layer structure as that shown in FIG. 5B. The a lithographic process is applied on these layers 21 and 22 to pattern the layers as 31 and 32 shown in FIG. 5C. The a portion of the resistive layer is etched to form resistor 132 and 134, the electrodes 131 and 133 and the heat dissipation layer 141 and 142 as shown in FIG. 5D. An electric casting process is applied to form the thick blocks 171 and 172 on top of the terminals 131 and 133 and the thick blocks 161, 162 and 163 on top of the heat dissipation layer 141 as that shown in FIG. 5E. A laser trimming process is carried out to adjust the resistance of the resistors 132 and 134 as that shown in FIGS. 4B and 5F. A protective layer 181 and 182 are formed on top of the resistors 132 and 134 and then cut as multiple sticks as shown in FIGS. 4C and 5G and 5H. A sputtering process is applied to form wrapping around electric terminals 171 and 172 with side surfaces 201, 202 and 203 as part of the electrodes as that shown in FIG. 5I. An barrier attaching layer such as a layer of titanium, chromium, or NiCr, or TiW are sputtered during the sputtering process in forming the electrodes. Then a conductive layer formed with cooper or nickel or NiCu alloy. After forming the side electrodes 201, 202, 203, each of the sticks are spliced into individual chips as shown in FIG. 5J and 4D. In FIG. 5K, each chip is further sputtered with cooper, nickel and SnPb to complete the manufacture of a low voltage, low resistance current detector.

The current detector as described above is provided with a heat dissipation wherein the thickness of the heat dissipation layer 14 may be flexibly adjusted to satisfy different kinds of applications. The electrodes are also made with a casting technique to increase the thickness for reduced resistance. The main body of the detector is formed with a multiple layered structure that can be conveniently manufactured by applying a same process for manufacturing printed circuit board (PCB). The cost of manufacturing the current detector is reduced because of the processes and materials are commonly used in the industries. The manufacturing processes as described above can be easily automated for mass-producing the chip as a current detector and thus significantly reduce the production costs.

Therefore, the current detect as disclosed above provides the advantage for reducing the resistance and increasing the heat dissipation. The technical limitations and difficulties of the prior art techniques are resolved by the disclosures of this invention.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A current detector formed on a multiple-layered structure with a resistor supported thereon wherein:
said multiple-layered structure further includes a heat dissipation layer for dissipating heat generated from said resistor.

2. The current detector of claim 1 further comprising:
conductive blocks formed by a microelectronic casting process for functioning as part of electrodes for said current detector.

3. The current detector of claim 1 further comprising:
wrapping around electrodes each with a side conductive surface wrapping around a side surface of said multiple-layered structure.
